(19) United States
(12) Patent Application Publication
(10) Pub. No.: US 2009/0066492 A1
(43) Pub. Date: Mar. 12, 2009

(54) In-vehicle communication apparatuses, methods, and programs

(75) Inventor: Tomoki Kubota, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-Shi (JP)

(21) Appl. No.: 12/230,749

(22) Filed: Sep. 4, 2008

(30) Foreign Application Priority Data
Sep. 7, 2007 (JP) 2007-232998
Sep. 7, 2007 (JP) 2007-233000

(51) Int. Cl. B60R 21/013; B60R 22/34

(52) U.S. Cl. 340/436; 701/78; 701/45

(57) ABSTRACT

In-vehicle communication apparatuses, methods, and programs store a database including a plurality of data groups. Each data group includes a plurality of frequencies and each frequency in each data group is associated with a predicted arrival time from a set point in the vicinity of an intersection to the intersection. The apparatuses, methods, and programs detect a state of the vehicle and predict an arrival time within which the vehicle will arrive at an approaching intersection based on the detected state of the vehicle. The apparatuses, methods, and programs determine a transmission frequency using the database and the predicted arrival time and cause a transmitter to transmit a signal having the determined transmission frequency.

### INCORPORATION BY REFERENCE

The disclosures of Japanese Patent Application No. 2007-232998, filed on Sep. 7, 2007, and Japanese Patent Application No. 2007-233000, filed on Sep. 7, 2007, including the specifications, drawings, and abstracts thereof, are incorporated herein by reference in their entirety.

### BACKGROUND

1. Related Technical Fields

The present invention relates to drive support for avoiding collisions at intersections.

2. Related Art

Communication with other vehicles has been used in order to avoid collisions at intersections. In inter-vehicle communication disclosed in Japanese Unexamined Patent Application Publication No. 2000-207679, a vehicle transmits a signal indicating its position and the time within which it traveled through a predetermined point to other vehicles. A vehicle having received the transmitted signal can detect the position of the transmitting vehicle.

### SUMMARY

A process of avoiding collisions at intersections requires immediacy and timeliness. The inter-vehicle communication described in Japanese Unexamnined Patent Application Publication No. 2000-207679 can be unsuitable for collision avoidance because it involves many items of transmission information and thus requires time for processing these items of information.

Accordingly, exemplary implementations of the broad inventive principles described herein provide a communication technique for communicating the time within which a vehicle enters an intersection to another vehicle using a simple process.

Exemplary implementations provide apparatuses, methods, and programs that store a database including a plurality of data groups. Each data group includes a plurality of frequencies and each frequency in each data group is associated with a predicted arrival time from a set point in the vicinity of an intersection to the intersection. The apparatuses, methods, and programs detect a state of the vehicle and predict an arrival time within which the vehicle will arrive at an approaching intersection based on the detected state of the vehicle. The apparatuses, methods, and programs determine a transmission frequency using the database and the predicted arrival time and cause a transmitter to transmit a signal having the determined transmission frequency.

### BRIEF DESCRIPTION OF THE DRAWINGS

Exemplary implementations will now be described with reference to the accompanying drawings, wherein:

FIG. 1 is a block diagram schematically illustrating main components of an exemplary system configuration;

FIG. 2 is a flowchart of an exemplary transmission method;

FIG. 3 is a table showing an example of the content of a node-frequency database (DB);

FIG. 4 is an illustration of the relationship among vehicles and nodes at an intersection;

FIG. 5 is a flowchart of an exemplary signal transmitting method;

FIG. 6 is a flowchart of an exemplary reception method; and

FIG. 7 is a flowchart of an exemplary signal receiving method.

### DETAILED DESCRIPTION OF EXEMPLARY IMPLEMENTATIONS

An exemplary in-vehicle communication apparatus will be described in detail with reference to the drawings. In this specification, the term “intersection” is used to refer to a point where roads intersect and includes the definition defined by traffic laws.

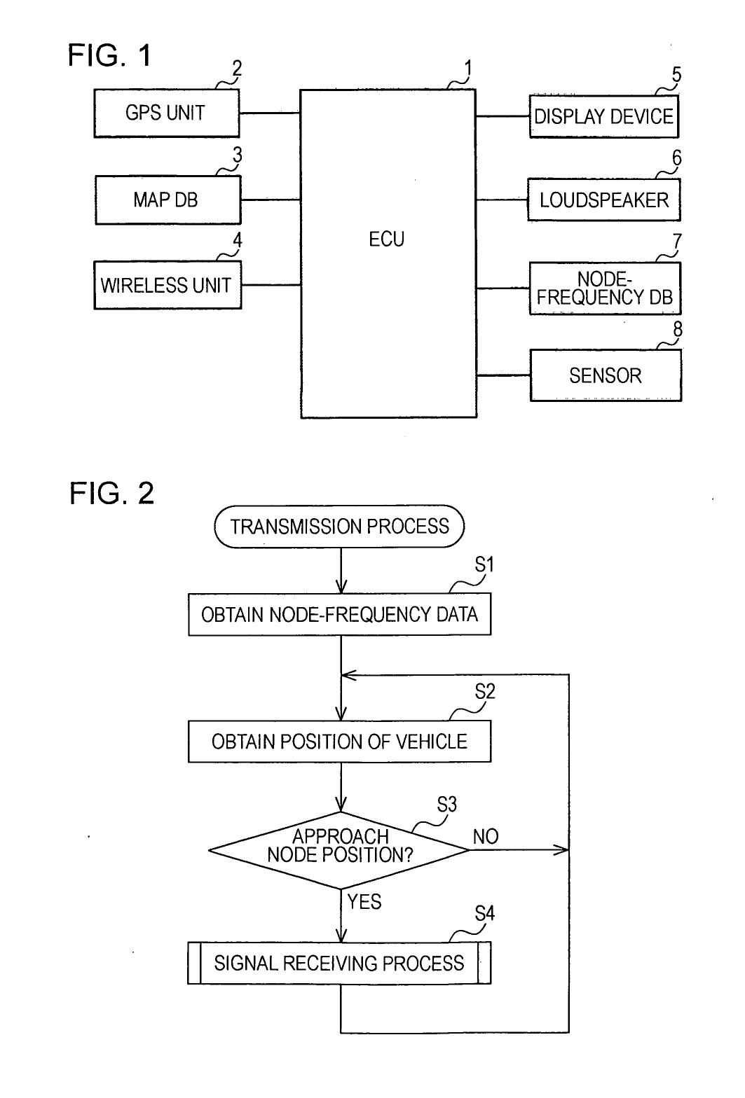

Referring to FIG. 1, the system configuration of the in-vehicle communication apparatus according to the present example is described. FIG. 1 is a block diagram schematically illustrating main components of the system configuration of the in-vehicle communication apparatus. As shown in FIG. 1, the in-vehicle communication apparatus according to the present example includes an electronic control unit (ECU) 1, a Global Positioning System (GPS) unit 2, a map database (DB) 3, a wireless unit 4, a display device 5, a loudspeaker 6, a node-frequency DB 7, and a sensor 8. The configuration shown in FIG. 1 includes portions that are necessary for the description of the present example. The in-vehicle communication apparatus may include various other components that are not shown in the block diagram.

The ECU 1 performs electronic control of the overall vehicle in which the in-vehicle communication apparatus is provided. The ECU 1 mainly includes an input interface that converts input signals from various devices, a controller such as a computer unit (microcomputer) that performs arithmetic operations of input data according to predetermined procedures and/or programs, and an output interface that converts the arithmetic results into actuator activating signals. The ECU 1 controls various components that are connected thereto.

The GPS unit 2 detects the position of the vehicle by measuring the arrival time of a radio wave emitted from an artificial satellite and calculating the distance from the artificial satellite. The GPS unit 2 is a component of a navigation system (not shown).

The map DB 3 stores various items of map data necessary for displaying route guidance, traffic information guidance, and maps. The map DB 3 is used in the navigation system (not shown). The map DB 3 includes node data and link data. An item of node data defines a predetermined position on a road using a node identification (node numbers), node coordinates (latitude and longitude), and the like. An item of link data defines a link ID, a link length, the coordinates of the start node and the termination node of a link, and the like. A link is defined between nodes.

The wireless unit 4 is configured to communicate with in-vehicle communication apparatuses provided in other vehicles. The wireless unit 4 can transmit and receive predetermined frequency signals whose band is not restricted. Various devices that are heretofore known can be used as the wireless unit 4.

The display device 5 is also constructed as part of the navigation system (not shown) and displays the position of the vehicle and roads. The display device 5 is also used to give various warnings to a user. The display device 5 may be implemented by a liquid crystal display or may be constructed as a touch panel display.

The loudspeaker 6 is also constructed as part of the navigation system (not shown) and used to output sounds giving route guidance, warnings, and the like. The loudspeaker 6 may also be shared by a music player (not shown).

The node-frequency DB 7 stores data in which a frequency is associated with each of a plurality of points set in the vicinity of a corresponding intersection according to the arrival times from the point to the intersection. The node-frequency DB 7 will be described in detail later. The content of the node-frequency DB 7 is common to vehicles.

The sensor 8 is a sensor for detecting the state of the vehicle. The state of the vehicle includes a vehicle velocity, brake information, and acceleration.

FIG. 2 is a flowchart illustrating an exemplary transmission method. The exemplary method may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

This exemplary method is executed while the vehicle is traveling. The in-vehicle communication apparatus may be configured to manually turn on/off the transmission method.

In step S1, the node-frequency data, which is stored in the node-frequency DB 7, is obtained. The content of the database may be distributed from a center (not shown). Alternatively, the in-vehicle communication apparatus may not include node-frequency data and may obtain the node-frequency data from the center (not shown) as needed. In that case, there is no node-frequency DB 7 in the vehicle.

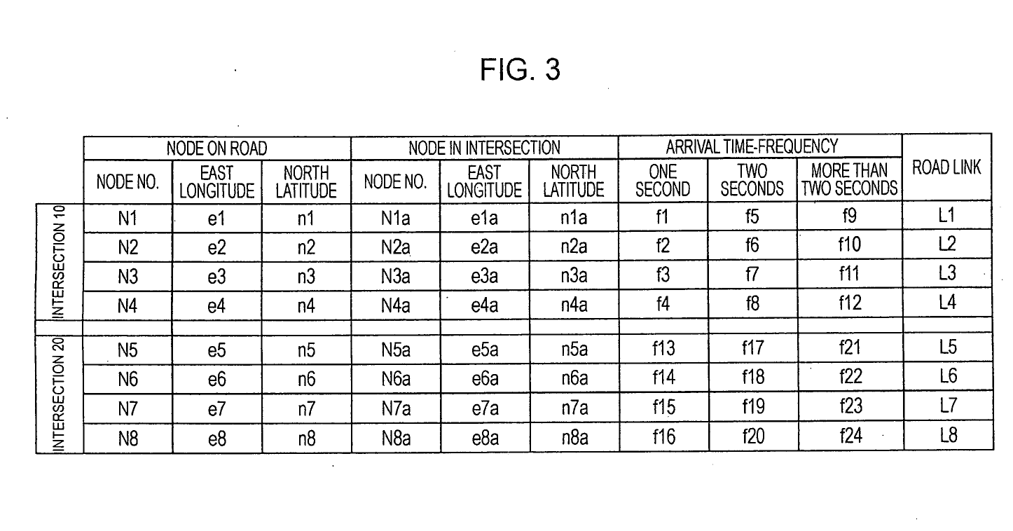

The node-frequency data stored in the node-frequency DB 7 will be described with reference to FIG. 3. For each intersection, a plurality of pairs of nodes are provided, each pair including a node on a roads and a node in the intersection. A plurality of frequencies are associated with each of the pairs. The time within which a vehicle enters each intersection is associated with each of the frequencies. Individual points on roads are defined using node numbers. The node numbers stored in the node-frequency DB 7 are common to node numbers in the map DB 3. Coordinate information corresponding to each of the node numbers can be obtained by referring to the map DB 3. Accordingly, the coordinate information in FIG. 3 may be omitted. The same applies to road links.

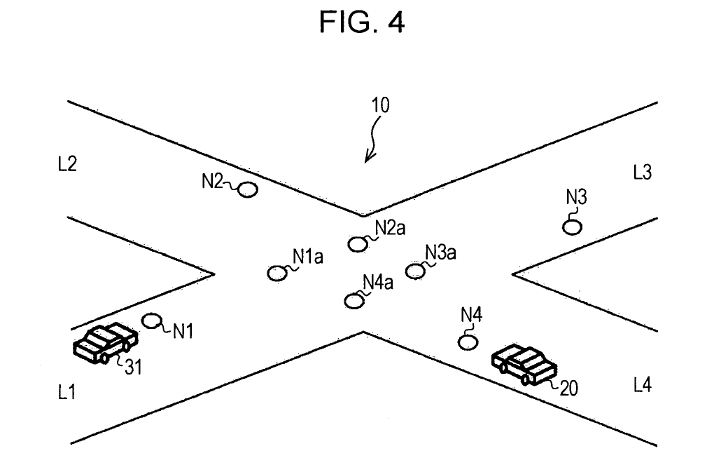

FIG. 4 illustrates the outline of node positions in the vicinity of an intersection 10. As shown in FIG. 4, nodes N1 to N4 are defined at predetermined points on roads in the vicinity of the intersection 10 (hereinafter points corresponding to nodes on roads are called “road node positions”). The road node positions of the nodes N1 to N4 are located near but outside the intersection 10. As shown in FIG. 4, nodes N1a to N4a are defined in the intersection 10 (hereinafter points corresponding to nodes in each intersection are called “intersection node positions”). The road node positions and the intersection node positions can be arbitrarily set.

Returning to FIG. 2, in step S2, the position of the vehicle is obtained using the GPS unit 2. In step S3, it is determined, on the basis of the obtained position of the vehicle, whether the vehicle has approached one of the road node positions defined in the node-frequency DB 7. Alternatively, it can be determined whether the vehicle has passed through one of the road node positions.

When it is determined that the vehicle has not approached one of the road node positions (NO in step S3), the method returns to step S2. That is, the method loops through steps S2 and S3 until the vehicle has approached one of the node positions.

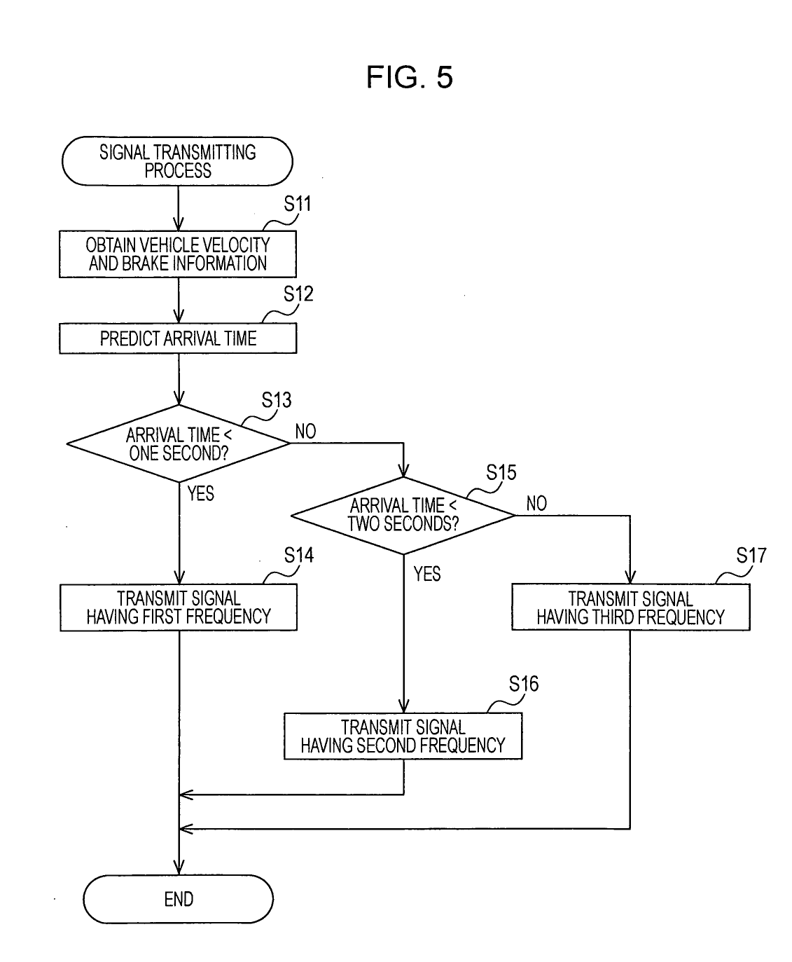

When it is determined that the vehicle has approached one of the road node positions (YES in step S3), the method proceeds to step S4 to transmit a signal. This signal transmitting may be performed by the exemplary method shown in FIG. 5.

The exemplary method of FIG. 5 may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

As shown in FIG. 5, in step S11, the velocity and brake information of the vehicle is obtained using the sensor 8. If needed, acceleration information may also be obtained. In step S12, an intersection node position corresponding to the road node position is determined as being approached by the vehicle in FIG. 2 (hereinafter referred to as the “approached node position”), and the arrival time within which the vehicle will arrives at the specified intersection node is predicted. The prediction of the arrival time is performed using the information obtained in step S11. Thereafter, the method proceeds to step S13.

In step S13, it is determined whether the arrival time predicted in step S12 is less than a first predetermined time (e.g., one second). When it is determined that the arrival time is less than the first predetermined time (YES in step S13), the method proceeds to step S14. When it is determined that the arrival time is not less than the first predetermined time (NO in step S13), the method proceeds to step S15.

In step S14, a signal having a first frequency associated with the approached node position is transmitted. In step S15, it is determined whether the arrival time predicted in step S12 is less than a second predetermined time (e.g., two seconds). When it is determined that the arrival time is less than the second predetermined time (YES in step S15), the method proceeds to step S16. When it is determined that the arrival time is not less than the second predetermined time (NO in step S15), the method proceeds to step S17.

In step S16, a signal having a second frequency associated with the approached node position is transmitted. In step S17, a signal having a third frequency associated with the approached node position is transmitted.

In the example illustrated in FIGS. 3 and 4, when the in-vehicle communication apparatus provided in the vehicle 31 determines that the arrival time within which the vehicle 31 arrives at the intersection node position N1a is less then one second, the in-vehicle communication apparatus in the vehicle 31 transmits a signal having a frequency f1. When it is determined that the arrival time is greater than or equal to one second and less than two seconds, the in-vehicle communication apparatus in the vehicle 31 transmits a signal having a frequency f5. When it is determined that the arrival time is two seconds or more, the in-vehicle communication apparatus in the vehicle 31 transmits a signal having a frequency f9.

According to the foregoing transmission method, an arrival time within which a vehicle arrives at an intersection can be communicated to another vehicle using a simple method of determining a transmission frequency on the basis of the predicted arrival time at the intersection and transmitting the determined frequency.

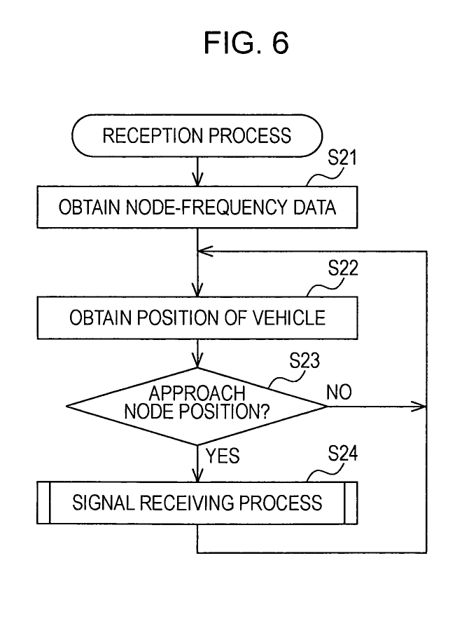

A reception method according to the present example will now herein be described with reference to FIG. 6. The exemplary method may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

This exemplary method is executed while the vehicle is traveling. The in-vehicle communication apparatus may be configured to manually turn on/off the reception method. The in-vehicle communication apparatus may alternately perform the reception method and the transmission method or may perform both the reception method and the transmission method in parallel.

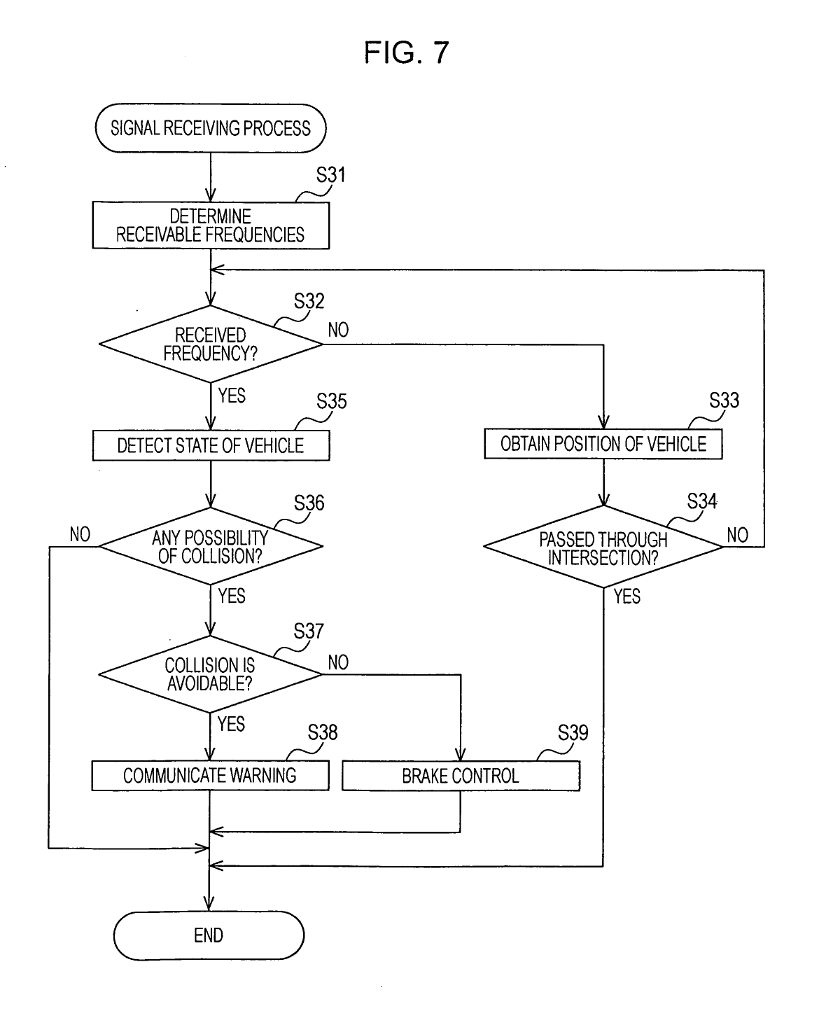

In the flowchart shown in FIG. 6, a method similar to the flowchart of the transmission method shown in FIG. 2 is performed. That is, steps S21 to S23 are the similar to steps S1 to S3 of FIG. 2. The only difference resides in that a signal receiving method is performed in step S24 when the vehicle approaches a road node position. The signal receiving method may be implemented by the exemplary method of FIG. 7.

The exemplary method of FIG. 7 may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

As shown in FIG. 7, in step S31, frequencies that can be received at the current position of the vehicle (hereinafter called “receivable frequencies”) are determined. The frequencies are determined on the basis of the road node position determined as being approached by the vehicle in step S23 of FIG. 6 (hereinafter referred to as the “approached node position”) and the node-frequency DB 7. In the example illustrated in FIG. 4, the road links (L1 and L3 in this case) intersecting a road link L4 on which the vehicle 20 is present are specified, and frequencies associated with road node positions (N1 and N3 in this case) on the specified road links are determined as receivable frequencies. Accordingly, the frequencies f1, f5, and f9 associated with the node N1 and the frequencies f3, f7, and f11 associated with the node N3 are determined as receivable frequencies.

In step S32, it is determined whether any one of the determined frequencies has been received. When it is determined that none of the frequencies have been received (NO in step S32), in step S33, the method obtains the position of the vehicle using the GPS unit 2.

In step S34, it is determined, on the basis of the obtained position of the vehicle, whether the vehicle has passed through the intersection. When it is determined that the vehicle has not passed through the intersection (NO in step S34), the method returns to step S32. When it is determined that the vehicle has passed through the intersection (YES in step S34), the signal receiving method ends.

When it is determined that one of the receivable frequencies has been received (YES in step S32), the method proceeds to step S35 where the state of the vehicle is detected. The detected state of the vehicle includes the position of the vehicle and the velocity of the vehicle. In addition, the brake operation amount may be detected. On the basis of the detected state of the vehicle, the arrival time within which the vehicle arrives at the intersection is predicted. Thereafter, the method proceeds to step S36.

In step S36, it is determined whether there is a possibility of collision at the intersection. Specifically, the possibility of collision is determined based on a predicted arrival time within which another vehicle will arrive at the intersection and the predicted arrival time within which the vehicle will arrive at the intersection. Here, the arrival time within which the other vehicle will arrive at the intersection is determined on the basis of the frequency of the received signal and the node-frequency DB 7.

When it is determined that there is no possibility of collision (NO in step S36), the signal receiving method ends. In contrast, when there is a possibility of collision (YES in step S36), where it is determined whether the collision can be avoided. When it is determined that the collision can be avoided (YES in step S37), the method proceeds to step S38 where content indicating that there is a possibility of collision is communicated using the display device 5 and/or the loudspeaker 6. Alternatively, the content may be communicated using light, vibration, or the like. Furthermore, content prompting the user to decelerate the vehicle may be communicated.

When it is determined that the collision is unavoidable (NO in step S37), the method proceeds to step S39 where the brakes are controlled, for example, to prevent the collision.

In steps S36 and S37 of FIG. 7 described above, the content of support is determined based on whether a possible collision is avoidable. Alternatively, when it is determined in step S36 that there is a possibility of collision, this possibility of collision may be classified into one of multiple levels (e.g., three levels), and the content of support may be determined based on the classified possibility. In this case, when a collision is of low possibility (first level), only a warning is communicated. When a collision is of relatively high possibility (second level), suspension control and/or brake-assist standby is performed. When a collision is of high possibility (third level where collision is unavoidable), the brakes are activated. When a collision is unavoidable, seatbelt-retracting control may additionally be performed.

In the example illustrated in FIG. 4, when the frequency f1 is received, it is determined that the arrival time within which the other vehicle arrives at the intersection is less than one second, and the content of support is determined on the basis of the state of the vehicle. When the frequency f5 is received, it is determined that the arrival time within which the other vehicle arrives at the intersection is greater than or equal to one second and less than two seconds, and the content of support is determined on the basis of the state of the vehicle.

According to the foregoing exemplary transmission and reception methods, the possibility of collision at an intersection is determined based on the frequency of a received signal and the state of a vehicle, and the content of support is determined based on the possibility of collision. Accordingly, the above methods can be performed simply and immediately to reliably avoid collisions at intersections.

In the foregoing example, different communication channels are provided by changing the frequency. Alternatively, multiple communication channels can be provided by changing the phase and/or amplitude of a signal. Transmitted/received signals may be analog or digital. A plurality of signals can be transmitted using time-division multiplexing.

According to the foregoing example, information regarding a vehicle can be communicated simply by transmitting/receiving a signal having a predetermined frequency using the node-frequency DB 7 whose content is common to a plurality of vehicles. Furthermore, the foregoing example has a particular technical advantage that information regarding other vehicles can be obtained.

Although the foregoing description mainly concerns the in-vehicle communication apparatus and method, the inventive principles can be realized as a computer-readable storage medium storing a computer-executable program including instructions that implement the above methods.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles. For example, the inventive principles can be realized as an in-vehicle communication apparatus that performs only the transmission method or the reception method.

What is claimed is:

1. An in-vehicle communication apparatus for a vehicle, comprising:
a memory storing a database including a plurality of data groups, each data group including a plurality of frequencies, each frequency in each data group being associated with a predicted arrival time from a set point in the vicinity of an intersection to the intersection; and
a controller specifically configured to:
detect a state of the vehicle;
predict an arrival time within which the vehicle will arrive at an approaching intersection based on the detected state of the vehicle;
determine a transmission frequency using the database and the predicted arrival time; and
cause a transmitter to transmit a signal having the determined transmission frequency.

2. The in-vehicle communication apparatus according to claim 1, wherein:
the detected state of the vehicle includes a position of the vehicle and a velocity of the vehicle; and
the controller is specifically configured to:
specify a set point and the approaching intersection on the basis of the detected position of the vehicle;
calculate an arrival time from the specified set point to the approaching intersection based on the detected velocity of the vehicle; and
determine a frequency corresponding to the specified set point and the calculated arrival time as the transmission frequency.

3. The in-vehicle communication apparatus according to claim 1, wherein the controller is specifically configured to:
determine receivable frequencies based on the state of the vehicle and the database;
receive a receivable signal from a receiver;
identify a frequency of the received signal;
predict an arrival time of another vehicle at the approaching intersection based on the received frequency;
determine whether a collision with the other vehicle is possible based on the predicted arrival time and the state of the vehicle; and
if there is a possibility of the collision, generate and communicate a warning.

4. The in-vehicle communication apparatus according to claim 3, wherein if there is a possibility of collision, the controller is specifically configured to:
determine whether the collision is avoidable based on the predicted arrival time and the state of the vehicle; and
if the collision is unavoidable, perform brake control.

5. The in-vehicle communication apparatus according to claim 3, wherein the controller is specifically configured to:
determine a level of the possibility of the collision with the other vehicle;
if the determined level is a low possibility, generate and communicate the warning;
if the determined level is a relatively high possibility, perform brake control and brake-assist standby; and
if the level is a high possibility, activate brakes.

6. The in-vehicle communication apparatus according to claim 5, wherein if the level is the high possibility, the controller is specifically configured to perform seatbelt retraction.

7. A navigation apparatus comprising the in-vehicle communication apparatus according to claim 1.

8. An in-vehicle communication method, comprising:
storing a database including a plurality of data groups, each data group including a plurality of frequencies, each frequency in each data group being associated with a predicted arrival time from a set point in the vicinity of an intersection to the intersection; and
detecting a state of a vehicle;
predicting an arrival time within which the vehicle will arrive at an approaching intersection based on the detected state of the vehicle;
determining a transmission frequency using the database and the predicted arrival time; and
causing a transmitter to transmit a signal having the determined transmission frequency.

9. The in-vehicle communication method according to claim 8, wherein:
the detected state of the vehicle includes a position of the vehicle and a velocity of the vehicle; and
the method further comprises:
specifying a set point and the approaching intersection on the basis of the detected position of the vehicle;
calculating an arrival time from the specified set point to the approaching intersection based on the detected velocity of the vehicle; and
determining a frequency corresponding to the specified set point and the calculated arrival time as the transmission frequency.

10. The in-vehicle communication method according to claim 8, wherein the method further comprises:
determining receivable frequencies based on the state of the vehicle and the database;
receiving a receivable signal from a receiver;
identifying a frequency of the received signal;
predicting an arrival time of another vehicle at the approaching intersection based on the received frequency;
determining whether a collision with the other vehicle is possible based on the predicted arrival time and the state of the vehicle; and
if there is a possibility of the collision, generating and communicating a warning.

11. The in-vehicle communication method according to claim 10, wherein if there is a possibility of collision, the method further comprises:
determining whether the collision is avoidable based on the predicted arrival time and the state of the vehicle; and
if the collision is unavoidable, performing brake control.

12. The in-vehicle communication method according to claim 10, wherein the method further comprises:
determining a level of the possibility of the collision with the other vehicle;
if the determined level is a low possibility, generating and communicating the warning;
if the determined level is a relatively high possibility, performing brake control and brake-assist standby; and
if the level is a high possibility, activating brakes.

13. The in-vehicle communication method according to claim 12, wherein if the level is the high possibility, the method further comprises performing seatbelt retraction.

14. A computer-readable storage medium storing a computer-executable program usable for vehicle communication, the program comprising:
instructions for accessing a stored database including a plurality of data groups, each data group including a plurality of frequencies, each frequency in each data group being associated with a predicted arrival time from a set point in the vicinity of an intersection to the intersection; and
instructions for detecting a state of a vehicle;
instructions for predicting an arrival time within which the vehicle will arrive at an approaching intersection based on the detected state of the vehicle;
instructions for determining a transmission frequency using the database and the predicted arrival time; and
instructions for causing a transmitter to transmit a signal having the determined transmission frequency.

15. The storage medium according to claim 14, wherein:
the detected state of the vehicle includes a position of the vehicle and a velocity of the vehicle; and
the program further comprises:
instructions for specifying a set point and the approaching intersection on the basis of the detected position of the vehicle;
instructions for calculating an arrival time from the specified set point to the approaching intersection based on the detected velocity of the vehicle; and
instructions for determining a frequency corresponding to the specified set point and the calculated arrival time as the transmission frequency.

16. The storage medium according to claim 14, wherein the program farther comprises:
instructions for determining receivable frequencies based on the state of the vehicle and the database;
instructions for receiving a receivable signal from a receiver;
instructions for identifying a frequency of the received signal;
instructions for predicting an arrival time of another vehicle at the approaching intersection based on the received frequency;
instructions for determining whether a collision with the other vehicle is possible based on the predicted arrival time and the state of the vehicle; and
instructions for generating and communicating a warning when there is a possibility of the collision.

17. The storage medium according to claim 16, wherein the program further comprises:
instructions for determining whether the collision is avoidable based on the predicted arrival time and the state of the vehicle when the collision is possible; and
instructions for performing brake control when the collision is unavoidable.

18. The storage medium according to claim 16, wherein the program further comprises:
instructions for determining a level of the possibility of the collision with the other vehicle;
instructions for generating and communicating the warning when the determined level is a low possibility;
instructions for performing brake control and brake-assist standby when the determined level is a relatively high possibility; and
instructions for activating brakes when the level is a high possibility.

19. The storage medium according to claim 18, wherein the program further comprises instructions for performing seatbelt retraction when the level is the high possibility.
